(19) United States
(12) Patent Application Publication
(10) Pub. No.: US 2008/0241706 A1
(43) Pub. Date: Oct. 2, 2008

(54) HOLOGRAPHIC DATA STORAGE MEDIUM AND FABRICATION METHOD THEREOF

(75) Inventors: Ming-Chia Li, Taichung County (TW); Chih-Ming Lin, Taichung City (TW); An-Tze Lee, Taipei County (TW); Chin-Tien Yang, Taipei County (TW); Ming-Fang Hsu, Taipei County (TW); Chien-Liang Huang, Taoyuan County (TW); Tzuan-Ren Jeng, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/694,527

(22) Filed: Mar. 30, 2007

(51) Int. Cl. G11B 7/0065

(52) U.S. Cl. 430/2

(57) ABSTRACT

A holographic data storage medium and a fabrication method thereof are provided. First, a precursor solution including an ultraviolet curable adhesive composition including a monomer having at least one (meth)acryloyl group in the molecule and an oligomer having at least two (meth)acryloyl groups in the molecule, a photopolymerizable organic compound and a photoinitiator including 2, 4, 6 trimethyl benzoldiphenyl phosphine oxide is provided. Next, a first substrate and a second substrate are attached to one another such that a gap is formed between the first and second glass substrates. Next, the precursor solution is filled into the gap. Next, the precursor solution between the first and second substrates is irradiated with a light in an atmosphere of an inert gas to induce photo-polymerization reaction to form the recording layer.

### BACKGROUND OF THE INVENTION

1. Field of the Invention

The present invention generally relates to an optical data storage medium, and more particularly to a holographic data storage medium and a fabrication method thereof.

2. Description of the Related Art

Holographic storage is data storage of holograms. Holograms are images of three dimensional interference patterns created by intersection of two beams of light, namely a reference beam and a signal beam, in a photosensitive medium. The superposition of the reference beam and the signal beam containing digitally encoded data forms an interference pattern within the volume of the medium causing a chemical reaction that changes or modulates the refractive index of the photosensitive medium. This modulation serves to record as the hologram including both the intensity and phase information from the signal. The hologram can be retrieved by exposing the storage medium to the reference beam alone, which interacts with the stored holographic data to generate a reconstructed signal beam proportional to the initial signal beam used to store the holographic image.

Each hologram may contain 1 to 10⁶ or more bits of data. One distinct advantage of holographic storage over surface-based storage formats, including CDs or DVDs, is that a large number of holograms may be stored in an overlapping manner in the same volume of the photosensitive medium using a multiplexing technique, such as by varying the signal and/or reference beam angle, wavelength, or medium position. However, major issues toward the realization of holographic storage as a viable technique lies on the reliable and economically feasible storage medium.

The holographic data storage medium typically comprises a mixture of at least a thermal-polymerizable liquid matrix precursor, a polymerizable monomer and a photo initiator. The fabrication of the holographic storage medium may be described as follows. First, a precursor solution including a homogeneous mixture of at least a thermal-polymerizable liquid matrix precursor, a polymerizable monomer and a photo initiator is provided. Next, a first glass substrate and a second glass substrate are attached to one another such that a gap is formed between the first and second glass substrates. Next, the precursor solution is filled into the gap. Next, the resulting structure is transferred into an oven and heated at 50-150° C. for at least 24 to 48 hours to induce thermal polymerization reaction to form a recording layer between the first and second glass substrates.

However, the thermal polymerization reaction step is too long and substantially reduces the throughput.

Thus, there remains a need for improved polymer systems suitable for holographic data storage media where the polymerization reaction step can be achieved in a comparatively shorter time to effectively increase the throughput, and also to promote the reliability and reduce the fabrication cost.

### SUMMARY OF THE INVENTION

Accordingly, the present invention is directed to a holographic data storage medium having the advantages of being fabricated at a comparatively higher throughput rate, and exhibit advantageous features such as high reliability and high stability.

The present invention is also directed to a method of fabricating a holographic data storage medium, wherein the overall fabrication time is substantially reduced so that the fabrication throughput is increased, and the reliability and the stability of the holographic data storage medium are effectively promoted.

According to an embodiment of the present invention, the holographic data storage medium comprises two substrates and a recording layer disposed between the two substrates. The recording layer comprises a polymer matrix formed from a cured ultraviolet (UV) curable adhesive composition and a photoinitiator used for facilitating curing of the UV curable adhesive composition under the UV light, and a photopolymerizable organic compound and a photoinitiator used for recording.

According to an embodiment of the present invention, the UV curable adhesive composition is composed of 20-95 wt/wt % of a monomer having at least one (meth)acryloyl group in the molecule and 5-80 wt/wt % of an oligomer having at least two (meth)acryloyl groups in the molecule. The photoinitiator used for facilitating the curing of the UV curable adhesive composition comprises 2, 4, 6 trimethyl benzoldiphenyl phosphine oxide. The photopolymerizable organic compound comprises a mono-acrylate group, a poly-acrylate group and an epoxy group. The photoinitiator used for recording comprises phenanthraquinone. The UV curable adhesive composition may be induced by the UV light to form a polymer matrix, and the photopolymerizable organic compound and the photoinitiator used for recording may be induced by the recording light to form interference fringes forming holograms and record information thereby.

According to an embodiment of the present invention, the method of fabricating the holographic data storage medium may be described as follows. First, a precursor solution including a mixture of at least a photoinitiator and UV curable adhesive composition, a photopolymerizable organic compound and a photoinitiator is provided. Next, a first substrate and a second substrate are attached to one another such that a gap is formed between the first and second substrates. Next, the precursor solution is filled into the gap. Next, the resulting structure is irradiated with a UV light in an atmosphere of an inert gas to induce photo-polymerization reaction to form a polymer matrix as the recording layer between the first and second substrates.

According to an embodiment of the present invention, the UV curable adhesive composition is composed of 20-95 wt/wt % of a monomer having at least one (meth)acryloyl group in the molecule and 5-80 wt/wt % of an oligomer having at least two (meth)acryloyl groups in the molecule, the photoinitiator used for facilitating the curing of the UV curable adhesive composition comprises 2, 4, 6 trimethyl benzoldiphenyl phosphine oxide, the photoinitiator used for recording comprises phenanthraquinone and the photopolymerizable organic compound comprises a mono-acrylate group, a poly-acrylate group and an epoxy group. The UV curable adhesive composition may be induced by the UV light to form a polymer matrix, and the photopolymerizable organic compound and the photoinitiator used for recording may be induced by the recording light to form interference fringes forming holograms and record information thereby.

According to an embodiment of the present invention, the precursor solution within the gap between the first and second substrates is irradiated by the light for 0.1˜120 seconds to form the recording layer.

According to an embodiment of the present invention, the precursor solution between the first and second glass substrates is irradiated by using UV light for 0.1˜120 seconds to form the recording layer.

According to an embodiment of the present invention, the inert atmosphere includes nitrogen gas.

In order to make the aforementioned and other objects, features and advantages of the present invention comprehensible, various embodiments accompanied with figures is described in detail below.

### BRIEF DESCRIPTION OF THE DRAWINGS

FIG. 1 is a schematic cross-sectional view showing a transmission hologram recording layer suitable for a two-beam holography according to an embodiment of the present invention.

FIG. 2 is a schematic cross-sectional view showing a reflective hologram recording layer suitable for a collinear holography according to another embodiment of the present invention.

FIG. 3 is a flowchart illustrating a method for fabricating a holographic data storage medium according to an embodiment of the present invention.

FIG. 4 is a view a two-beam holography apparatus for conducting recording/reproduction of the holographic data storage medium.

FIG. 5 is a view showing an example of an angle-diffraction efficiency relationship in an angular multiplex recording/reproduction test.

### DETAILED DESCRIPTION OF THE INVENTION

In the following, holographic data storage medium according to various embodiments of the present invention are described.

The holographic data storage medium according to an embodiment of the present invention includes first and second substrates, and a recording layer formed between the first and second substrates. In addition, the holographic data storage medium may be suitably provided with a reflective layer, an intermediate layer, a protective layer, a spacer and the like as will be explained later.

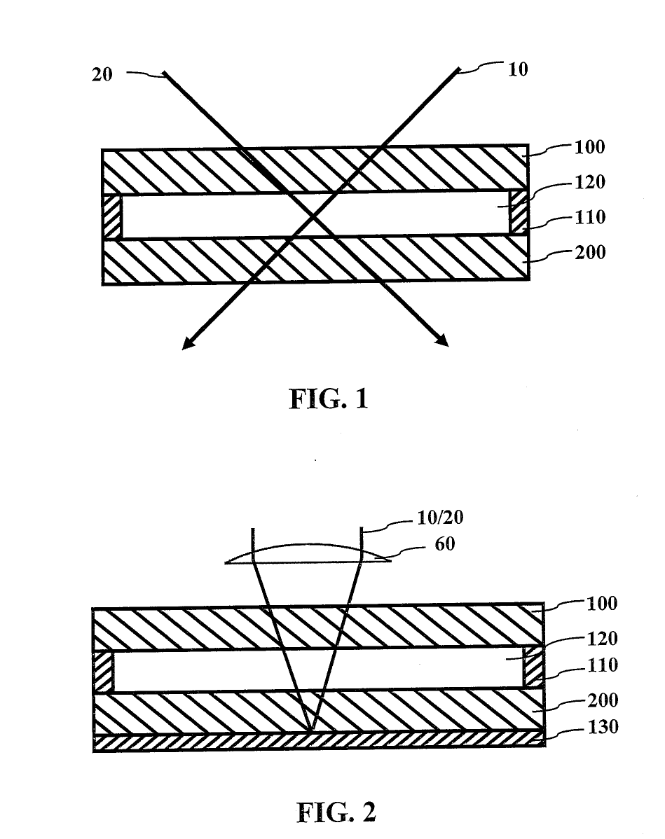

FIG. 1 is a schematic cross-sectional view showing a holographic data storage medium according to a first embodiment of the present invention, wherein the holographic data storage medium is an example of a transmission type holographic data storage medium suitable for a two-light beam holography, and a recording light and a reference light in the vicinity thereof. The holographic data storage medium comprises a first substrate 100 and a second substrate 200, a spacer 110 supported there-between, and a recording layer 120 surrounded by the spacer 110 and between the first and second substrates 100 and 200. Though not illustrated, the recording layer 120 includes a polymer matrix formed by a reaction of a UV curable adhesive composition and a photoinitiator used for facilitating curing of the UV curable adhesive composition, and a photopolymerizable organic compound and a photoinitiator used for recording. A recording light 10 and a reference light 120 mutually cross in a desired position within the recording layer 120 such that the recording light 10 induces the polymerizable organic compound and the photoinitiator used for recording to form interference fringes thereby recording information.

FIG. 2 is a schematic cross-sectional view showing a holographic data storage medium according to a second embodiment of the present invention, wherein the holographic data storage medium is an example of a reflective type holographic data storage medium suitable for a collinear (coaxial) holography, and a recording light and a reference light in the vicinity thereof. The reflective type holographic data storage medium comprises a first substrate 100 and a second substrate 200, a spacer 110 supported there-between, a recording layer 12 surrounded by the spacer 110 and between the first and second substrate 100 and 200, and a reflective layer 130 disposed on a surface of the second substrate 200 opposite to a side of the recording layer 120. Though not illustrated, the recording layer 120 includes a three-dimensionally cross-linked polymer matrix comprising a cured reaction product of a photo polymerization initiator and a photo-curable compound. A recording light 10 and a reference light 20 are condensed by a lens 60 and focused on the surface of the reflective layer 130. In this state, the recording light 10 and the information light 20 form interference fringes in a desired position in the recording layer 120, thereby recording information.

In the foregoing, the transmission hologram recording layer is explained by a two-beam holography and the reflective hologram recording layer is explained by a collinear holography, but other combinations are also possible, such as a transmission hologram recording layer utilizing collinear holography.

According to an embodiment of the present invention, the recording layer 120 has, for example but not limited to, a thickness within a range of about 20 μm to 2 mm for providing a sufficient memory capacity and a high resolution.

According to an embodiment of the present invention, the UV curable adhesive composition may be induced by the UV light to form a polymer matrix, and the polymerizable organic compound and the photoinitiator used for recording may be induced by the recording light 10 to form interference fringes forming holograms and record information thereby. Suitable additives and the like may also be added.

According to an embodiment of the present invention, the UV curable adhesive composition is composed of 20-95 wt/wt % of a monomer having at least one (meth)acryloyl group in the molecule and 5-80 wt/wt % of an oligomer having at least two (meth)acryloyl groups in the molecule. The photoinitiator used for recording comprises phenanthraquinone and the photoinitiator used for facilitating the curing of the UV curable adhesive composition under the UV light comprises 2, 4, 6 trimethyl benzoldiphenyl phosphine oxide. The 2, 4, 6 trimethyl benzoldiphenyl phosphine oxide has the following chemical structural formula.

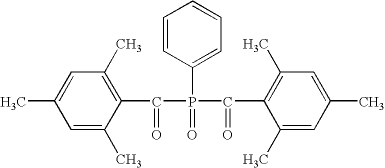

The recording layer 120 has a sufficient strength and superior flexibility exhibiting negligible physical change during temperature changes over a wide range, superior heat resistance and superior resistance to hydrolysis. Thus, the recording layer 120 exhibit superior long term reliability with negligible physical changes over time, superior resistance to chemicals such as acids and alkalis and low moisture and water absorption.

According to an embodiment of the present invention, the second substrate 200 has a transmittance of about 0.01-95% at all wavelengths of energy beams in a region not less than 280 nm but not more than 380 nm.

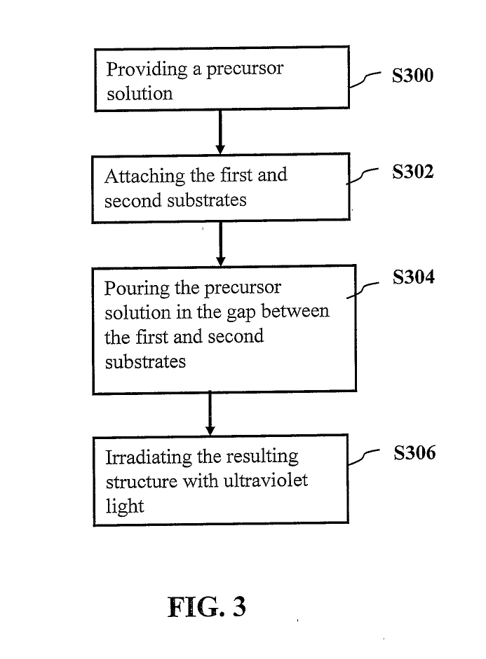

Hereinafter, the method of fabricating the holographic data storage medium according to an embodiment of the present invention may be described with reference to FIG. 3 as follows. First, at step S300, a precursor solution including a mixture of at least a photo-curable resin comprising a monomer and an oligomer, a photoinitiator used for facilitating curing of the UV curable adhesive composition, a photopolymerizable organic compound and a photoinitiator used for recording is provided. Next, at step S302, a first substrate 100 and a second substrate 200 are attached to one another with a spacer 110 there-between such that a gap is formed between the first and second substrates 100 and 200. Next, at step S304, a precursor solution is filled into the gap. Next, step S306, the resulting structure is irradiated with a light in an atmosphere of an inert gas to induce photo-polymerization reaction to form a recording layer 120 between the first and second substrates 100 and 200.

According to an embodiment of the present invention, the UV curable adhesive composition is composed of 20-95 wt/wt % of a monomer having at least one (meth)acryloyl group in the molecule and 5-80 wt/wt % of an oligomer having at least two (meth)acryloyl groups in the molecule_and the photoinitiator used for facilitating curing of the UV curable adhesive composition under UV light comprises 2, 4, 6 trimethyl benzoldiphenyl phosphine oxide. The UV curable adhesive composition may be induced by the UV light to form a polymer matrix. The photopolymerizable organic compound comprises a mono-acrylate group, a poly-acrylate group and an epoxy group. The photoinitiator used for recording comprises phenanthraquinone. The photopolymerizable organic compound and the photoinitiator used for recording may be induced by the recording light to form interference fringes forming holograms and record information thereby.

According to an embodiment of the present invention, the precursor solution within the gap between the first and second glass substrates is irradiated by the light for 0.1-2 minutes at room temperature to form the recording layer 120 between the first and second substrates 100 and 200.

According to an embodiment of the present invention, the precursor solution between the first and second glass substrates is irradiated by using a UV light for 0.1˜120 seconds to form the recording layer.

According to an embodiment of the present invention, the inert atmosphere includes nitrogen gas.

The precursor solution comprising the photoinitiator used for recording, the photopolymerizable organic compound, the UV curable adhesive composition composed of a monomer having at least one (meth)acryloyl group in the molecule and an oligomer having at least two (meth)acryloyl groups in the molecule and the photoinitiator including 2, 4, 6 trimethyl benzoldiphenyl phosphine oxide (the chemical structure is shown below), have a sufficiently low viscosity to be easily poured into the gap between the gap of the first and second substrates 100 and 200, and provide good reproducible results at a high curing rate. Furthermore, the cured product obtained upon irradiation of the precursor solution between the first and second substrates 100 and 200 has sufficient strength and superior quality exhibiting negligible physical change during temperature changes over a wide range, superior heat resistance and superior resistance to hydrolysis. Thus, the recording layer 120 obtained by the above process exhibit superior long term reliability with negligible physical changes over time, superior resistance to chemicals such as acids and alkalis and low moisture and water absorption.

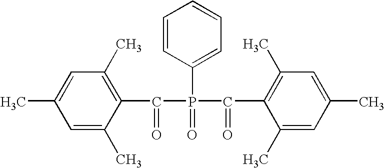

The high curing rate with high reproducible result of the fabrication method of the present invention makes it feasible for mass production of reliable and high quality holographic data storage media with sufficiently acceptable quality. The UV light quickly cures the ultraviolet curable adhesive composition composed of a monomer having at least one (meth)acryloyl group in the molecule and an oligomer having at least two (meth)acryloyl groups in the molecule and photoinitiator including 2, 4, 6 trimethyl benzoldiphenyl phosphine oxide to form the recording layer 120 of the holographic data storage medium.

In the recording layer 120, other additives such as a sensitizer, a defoamer, a colorant and a color erasing agent may be suitably added.

Examples of sensitizer includes cyanine, merocyanine, xanthene, coumarine or eosin, and one or more kinds of such compounds.

A defoamer may be used for removing bubbles during the preparation of the precusor solution, and can be, for example, a silane coupling agent.

A colorant may be used for improving absorption of the recording light and the reference light.

A color erasing agent may be used for improving a diffraction efficiency.

The first substrate 100 has a translucency to the lights employed in recording/reproduction of hologram, such as a recording light 10, a reference light 20, a servo light etc., namely visible to near-ultraviolet light.

Examples of the material of the first substrate 100 includes glass or plastic with high mechanical strength.

Examples of glass includes soda lime glass, lead glass, borosilicate glass and quartz glass.

Examples of plastics include polycarbonate resin, norbornene resin, cycloolefin resin, polyallylate, polymethyl methacrylate, polystyrene, poly(ethylene dimethylacrylate), polydiethylene glycol bis(allyl carbonate), polyphenylene oxide and polyethylene terephthalate.

The first substrate 100 may be formed by a material without a birefringence, and may have a thickness within a range of about 100 μm to about 1.2 mm.

The second substrate 200 has a translucency to the lights employed in recording/reproduction of hologram, such as a recording light 10, a reference light 20, a servo light etc., namely visible to near-ultraviolet light.

The material and a thickness of the second substrate 200 are similar to those of the first substrate 100.

The second substrate 200 is disposed on a surface opposite to the recording layer 120, and has a pregrooving for positioning. For achieving a detailed positioning, the pregrooving preferably has a pitch of projecting parts smaller than a recording shift.

Also in case of a reflective hologram recording layer, the second substrate 200 may have a thickness of about 100 μm or larger so as to reduce a power density of the recording light within the recording layer, and thereby reduce a shift multiplex distance and realize a high recording density.

The second substrate comprises, for example, a transmittance in a range of 0.01-20% at all wavelengths of energy beams in a region not less than 280 nm but not more than 380 nm.

The holographic data storage medium may further include a reflective layer 130, an intermediate layer, a protective layer, a spacer and the like.

A reflective layer 130 is disposed on a surface of the second substrate 200 opposite to a side of the recording layer 120.

The reflective layer 130 is preferably formed by a material having a high reflectance to the recording light, the reference light and the servo light. The reflective layer 130 may comprise Al alloy, Ag alloy, Au alloy, Cu alloy or TiN.

The reflective layer 130 may have a thickness in a range of about 50-100 nm or larger in order to realize a sufficient reflectance.

An intermediate layer may be disposed between the recording layer 120 and the first substrate 100, or between the recording layer 120 and the second substrate 200. This serves to suppress a reaction between a component of the first substrate 100 or the second substrate 200 and a component of the recording layer 120.

The intermediate layer may be formed by a material having a high transmittance to the recording light, the reference light and the servo light, and having a refractive index close to that of the recording layer 120, the first substrate 100 and the second substrate 200.

Examples of the material of the intermediate layer include magnesium fluoride, calcium fluoride, zirconium fluoride, palladium fluoride, barium fluoride, cesium bromide, cesium iodide, magnesium oxide, aluminum oxide, silicon oxide, titanium oxide, chromium oxide, zinc oxide, yttrium oxide, zirconium oxide, indium oxide, tin oxide, tellurium oxide, cerium oxide, hafnium oxide, tantalum oxide, boron nitride, silicon nitride, aluminum nitride, zirconium nitride, silicon carbide, zinc sulfide, barium titanate and diamond.

A protective layer may be disposed on an outermost surface of the hologram recording layer 120.

The protective layer may be formed by a material having a high transmittance to the recording light, the reference light and the servo light, and having a refractive index close to that of the recording layer, the first substrate and the second substrate. The protective layer may be formed by a glass, a transparent resin, or a material mentioned for the intermediate layer.

The spacer 110 is used for obtaining a desired thickness of the recording layer 120. The spacer 110 is formed by a material having a low mutual solubility with components of the recording layer 120. Examples of the material of the spacer include a glass plate, glass beads, a resin, and a metal plate.

An example of a method for fabricating a hologram recording layer according to an embodiment of the present invention may be described as follows.

<Preparation of Precursor Solution>

0.05 g of phenanthraquinone (Aldrich grade) and 1.0 g of methyl acrylic acid cyclohexyl ether acrylic monomer were added into flask containing 19.0 g of UV curable adhesive composition KAYASORB DVD-750 and mixed in ultrasonic mixing system for 15 minutes to form a precursor solution.

<Fabrication of Holographic Data Storage Medium>

The first substrate 100 and the second substrate 200 were attached to one another with a spacer 110 there-between such that a gap is formed between the first and second substrates 100 and 200. Thereafter, the above precursor solution was filled into the gap. Next, the resulting structure was irradiated with a UV light (Mineral light lamp, Model UVGL-25,λₘₐₓ=365nm) in an atmosphere of nitrogen gas to induce photo-polymerization reaction within the precursor solution for a duration of 1.5 minutes at room temperature to form the recording layer 120 having of a thickness of 600 μm.

<Recording/Reproduction Test of Recording Layer>

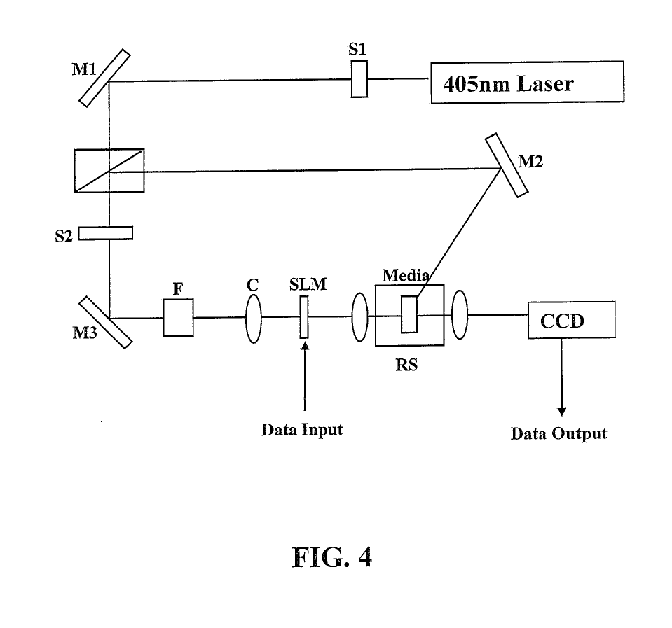

FIG. 4 shows a two-beam holography apparatus for conducting recording/reproduction test of the holographic data recording layer. The system is shown in FIG. 4 in a self illustrative manner, wherein the system comprises two shutters S1 and S2, three mirrors M1, M2 and M3, a filter F, a collimator C, a SLM and a rotary stage RS.

Each hologram recording layer of Examples 1-3 and comparative Examples 1-2 were placed on a rotary stage RS of the two-beam holography apparatus, and subjected to a recording and a reproduction test. A blue laser beam with a wavelength of 405 nm was employed as a light source. The following Table 1 shows the result of the test.

TABLE 1

| | Polymerization | | M# μm |
|---|---|---|---|
| TEST | process | Process conditions | (λₘₐₓ = 405 nm) |
| Test 1 | UV polymerization | Treated for 1.5 minutes | 3.40 |
| | (365 nm) | at room temperature | |
| Test 2 | UV polymerization | Treated for 1.0 minutes | 4.53 |
| | (365 nm) | at room temperature | |
| Test 3 | UV polymerization | Treated for 2.0 minutes | 2.99 |
| | (365 nm) | at room temperature | |
| Comparative test 1 | Thermal | Treated for 24 hours at | 3.50 |
| (recording layer | polymerization | 60° C. and then treated for | |
| disclosed in | | 48 hours at 80° C. | |
| US2006/0115740) | | | |
| Comparative test 2 | Thermal | Treated for 24 hours at | 1.80 |
| (recording layer | polymerization | 60° C. and then treated for | |
| disclosed in | | 48 hours at 80° C. | |
| US2006/0115740) | | | |

M/# provides a larger recording dynamic range and a superior multiplex recording ability. As can be seen from the above table, there is no significant difference in M/# between the recording layers obtained via UV polymerization according to the present invention and that obtained via thermal polymerization according to the prior art US patent publication No. 2006/0115740. It is therefore shown that a hologram recording layer obtained via UV polymerization according to the present invention have excellent recording sensitivity.

<Angular Multiplex Recording/Reproduction Test of Hologram Recording Layer>

Also, an angular multiplex recording/reproduction test was conducted on the hologram recording layer. Angular multiplex recordings of 41 pages were conducted using blue laser beam with a wavelength of 405 nm as the holographic recording light source.

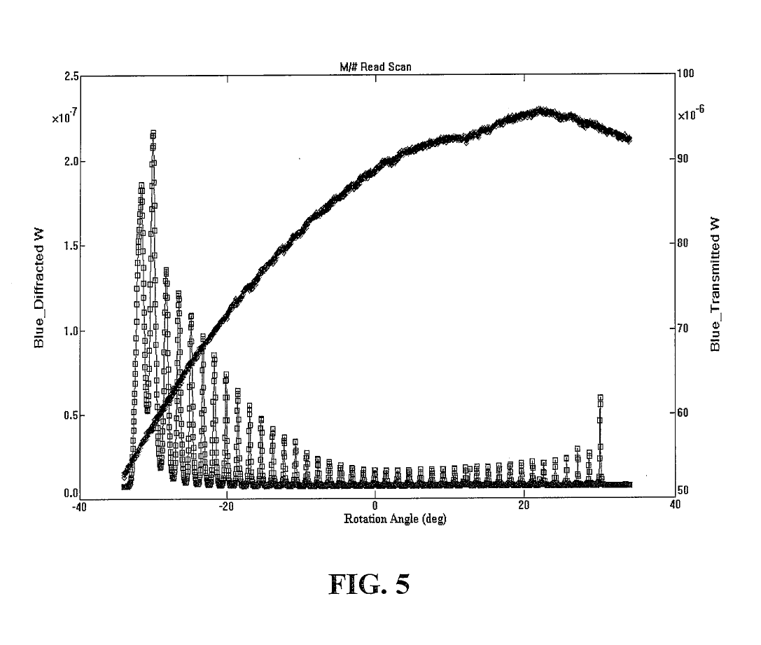

Then, after the medium was let to stand for 5 minutes for completion of the reaction, the rotary stage was put in a sweeping motion under the irradiation of the reference light only, and a diffraction efficiency was measured to obtain results as shown in FIG. 5.

M/# is defined by a following equation:

$$M \# = {\sum }_{i = 1}^{n} {η}_{I}^{\frac{1}{2}}$$

wherein ηi indicates, in an angular multiplex recording/reproduction of holograms of n pages, a diffraction efficiency measured from an i-th hologram, and M/# does not depend on n at a large number n of multiplexity (for example see L. Hesselink, S. S. Orlow, M. C. Bashaw, Holographic Data Storage Systems, Proceedings of SPIE, 2004, Vol. 92, pp 1231-1280).

Accordingly, the present invention at least has the following advantages.

The precursor solution comprising a ultraviolet curable adhesive composition comprising a monomer having at least one (meth)acryloyl group in the molecule and an oligomer having at least two (meth)acryloyl groups in the molecule and a photoinitiator used for UV curing comprising 2, 4, 6 trimethyl benzoldiphenyl phosphine oxide, a photopolymerizable organic compound and a photoinitiator used for recording, a photopolymerizable organic compound, have a sufficiently low viscosity to be easily poured into the gap between the gap of the first and second substrates 100 and 200, and provide good reproducible result at a high curing rate. Furthermore, the cured product obtained upon irradiation of the precursor solution between the first and second substrates 100 and 200 has sufficient strength and superior quality exhibiting negligible physical change during temperature changes over a wide range, superior heat resistance and superior resistance to hydrolysis. Thus, the recording layer 120 obtained by the above process exhibit superior long term reliability with negligible physical changes over time, superior resistance to chemicals such as acids and alkalis and low moisture and water absorption.

The UV light quickly cures the ultraviolet curable adhesive composition composed of a monomer having at least one (meth)acryloyl group in the molecule and an oligomer having at least two (meth)acryloyl groups in the molecule and photoinitiator is used for facilitating curing of the UV curable adhesive composition under UV light to form the recording layer 120 of the holographic data storage medium. Therefore, the high curing rate with high reproducible result of the fabrication method of the present invention makes it feasible for mass production of reliable and high quality holographic data storage media with sufficiently acceptable quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A holographic data storage medium, comprising:
a first substrate;
a second substrate; and
a recording layer between the first and second substrates, wherein the recording layer comprises a polymer matrix formed from a cured ultraviolet curable adhesive composition and a first photoinitiator, and a photopolymerizable organic compound and a second photoinitiator or photo-acid generator used for recording.

2. The holographic data storage medium according to claim 1, wherein the photopolymerizable organic compound comprises a mono-acrylate group, a poly-acrylate group and an epoxy group.

3. The holographic data storage medium according to claim 1, wherein the ultraviolet curable adhesive composition is composed of 20-95 wt/wt % of a monomer having at least one (meth)acryloyl group in the molecule and 5-80 wt/wt % of an oligomer having at least two (meth)acryloyl groups in the molecule and the first photoinitiator comprises comprising 2, 4, 6 trimethyl benzoldiphenyl phosphine oxide.

4. The holographic data storage medium according to claim 1, wherein the second photoinitiator or photo-acid generator used for recording comprises the derivatives of phenanthraquinone or camphorquinone.

5. The holographic data storage medium according to claim 1, wherein the second substrate comprises a transmittance in a range of 0.01-95% at all wavelengths of energy beams in a region not less than 280 nm but not more than 380 nm.

6. The holographic data storage medium according to claim 1, further comprising a reflective layer between the second substrate and the recording layer.

7. The holographic data storage medium according to claim 1, wherein the first and second substrates comprise a glass material or a plastic material.

8. The holographic data storage medium according to claim 1, wherein the first and second substrates have a thickness in a range of 100 μm to 1 mm.

9. The holographic data storage medium according to claim 1, wherein the recording layer has a thickness in a range of 20 μm to 2 mm.

10. A method of fabricating a holographic data storage medium, comprising:
providing a first substrate and a second substrate;
attaching the first and second substrates such that a gap is formed between the first and second substrates;
filling a precursor solution into the gap; and
irradiating the precursor solution in the gap with a light to induce a photo-polymerization reaction to form a recording layer.

11. The method of fabricating a holographic data storage medium according to claim 10, wherein the precursor solution comprises at least an ultraviolet curable adhesive composition and a second photoinitiator used for facilitating curing of the UV curable adhesive composition, a first photoinitiator used for recording and a photo-polymerizable organic compound.

12. The method of fabricating a holographic data storage medium according to claim 10, wherein the first photoinitiator comprises 2, 4, 6 trimethyl benzoldiphenyl phosphine oxide and the second photo initiator comprises the derivatives of phenanthraquinone or camphorquinone.

13. The method of fabricating a holographic data storage medium according to claim 10, wherein the ultraviolet curable adhesive composition is composed of 20-95 wt/wt % of a monomer having at least one (meth)acryloyl group in the molecule and 5-80 wt/wt % of an oligomer having at least two (meth)acryloyl groups in the molecule and a photoinitiator used for UV curing.

14. The method of fabricating a holographic data storage medium according to claim 10, wherein the step of irradiating the precursor solution in the gap between the first and second substrates is carried out for a duration ranging between 0.1-2 minutes using an ultraviolet light at a room temperature.

15. The method of fabricating a holographic data storage medium according to claim 10, wherein the step of irradiating the precursor solution in the gap between the first and second substrates is carried out in an atmosphere of an inert gas at a room temperature.

16. The method of fabricating a holographic data storage medium according to claim 15, wherein the inert gas comprises nitrogen.

17. The method of fabricating a holographic data storage medium according to claim 10, further comprising a step of forming a reflective layer between the second substrate and the recording layer.

18. The method of fabricating a holographic data storage medium according to claim 10, wherein the second substrate comprises a transmittance in a range of 0.01-95% at all wavelengths of energy beams in a region not less than 280 nm but not more than 380 nm.

19. The method of fabricating a holographic data storage medium according to claim 10, wherein the first and second substrates comprise a glass material or a plastic material.

20. The method of fabricating a holographic data storage medium according to claim 10, wherein the first and second substrates have a thickness in a range of 100 μm to 1 mm.
